(19) United States
(12) Patent Application Publication
(10) Pub. No.: US 2009/0115741 A1
(43) Pub. Date: May 7, 2009

(54) TOUCH SENSOR AND TOUCH SCREEN PANEL

(75) Inventors: Wen-Chun Wang, Taichung City (TW); Chien-Ting Chan, Changhua County (TW); Chun-Chin Chang, Taichung County (TW); Wen-Tui Liao, Taichung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/265,766

(22) Filed: Nov. 6, 2008

Related U.S. Application Data
(60) Provisional application No. 60/985,660, filed on Nov. 6, 2007.

(30) Foreign Application Priority Data
Mar. 21, 2008 (TW) 97110190
Apr. 16, 2008 (CN) 200810092619.4
Oct. 22, 2008 (TW) 97140540

(51) Int. Cl. G06F 3/041

(52) U.S. Cl. 345/173

(57) ABSTRACT

A touch sensor includes a first substrate, a second substrate, an inducing electrode and an inducing switch. The second substrate is disposed opposite the first substrate. The inducing electrode is disposed on the first substrate. The inducing switch disposed on the second substrate includes a first switch electrode, a second switch electrode and an active layer, which is disposed between and contacts with the first switch electrode and the second switch electrode. The active layer and the inducing electrode face each other and are separated by a distance. When the first substrate or the second substrate is pressed so that the distance between the inducing electrode and the active layer is changed, the driven inducing electrode induces a channel, corresponding to a change of the distance, on the active layer to electrically connect the first switch electrode to the second switch electrode.

This application claims the benefits of U.S. application Ser. No. 60/985,660, filed Nov. 6, 2007, Taiwan applications Serial No. 97110190, filed Mar. 21, 2008, and 97140540, filed Oct. 22, 2008, the subject matter of which is incorporated herein by reference.

### BACKGROUND OF THE INVENTION

1. Field of the Invention

The invention relates in general to a touch sensor and a touch screen panel thereof, and more particularly to a touch sensor, which generates an induced channel when being pressed, and a touch screen panel thereof.

2. Description of the Related Art

The technology of the touch screen panel has been widely applied to portable electronic devices, such as a mobile phone, a notebook computer, a music player (MP3), a personal digital assistant (PDA), a global satellite positioning system (GPS), an ultra mobile personal computer (UMPC), and the like.

Conventionally, the methods for utilizing the touch screen panel mainly include a resistive inducing method and a capacitive including method. According to the principle of the resistive inducing method, two separate and transparent conductive films, such as film resistors, cover a surface of a screen panel. When the screen panel is pressed, the conductive films will contact with each other and the voltage variation is generated. According to the capacitive inducing method, multiple transparent conductive films are coated on the screen panel, and a bias voltage is applied to the electrodes on two sides of the conductive films so that the uniform low-voltage electric field is generated on the screen panel. When the screen panel is induced by the electrostatic charges, such as the electrostatic charges of the finger, the conductive films may have the capacitive potential variation. Thus, according to the positioning method of the conductive films, the touched position can be obtained due to the voltage variation or the potential variation.

In addition, Planar Systems, Inc. has disclosed a design for optical touch panel circuit (Active Matrix LCD with Integrated Optical Touch Screen), in which photo thin-film transistors (TFTs) are disposed in the pixel array of the panel. Thus, the driven photo TFT generates the voltage variation under the change of the ambient light, and the touched position can be obtained according to the voltage variation. However, the optical touch panel is significantly influenced by the variation of the ambient light. That is, the operation sensitivity of the circuit is greatly reduced under the ambient light with the low luminance so that the touched position cannot be correctly judged.

### SUMMARY OF THE INVENTION

The invention is directed to a touch sensor and a touch screen panel. The touch sensor works based on a circuit structure of the panel. When the panel is touched, a distance between a driven electrode and an active layer of a corresponding switch is changed so that a channel is induced on the active layer and a corresponding induced signal is generated. In addition, many touch sensors are integrated in the screen panel to form the touch screen panel, such as a single-touch or multi-touch touch screen panel.

According to a first aspect of the present invention, a touch sensor including a first substrate, a second substrate, an inducing electrode and an inducing switch is provided. The second substrate is disposed opposite the first substrate. The inducing electrode is disposed on the first substrate. The inducing switch disposed on the second substrate includes a first switch electrode, a second switch electrode and an active layer. The active layer is disposed between and contacts with the first switch electrode and the second switch electrode. The active layer and the inducing electrode face each other and are separated from each other by a distance. When the first substrate or the second substrate is pressed so that the distance between the inducing electrode and the active layer is changed, the driven inducing electrode induces a channel corresponding to the change of the distance on the active layer so that the first switch electrode is electrically connected to the second switch electrode.

According to a second aspect of the present invention, a touch screen panel including a first substrate, a second substrate, a pixel array and a number of touch sensors is provided. The second substrate is disposed opposite the first substrate. The pixel array is disposed between the first substrate and the second substrate. Each of the touch sensors includes an inducing electrode and an inducing switch. The inducing electrode is disposed on the first substrate. The inducing switch is disposed on the second substrate. The inducing switch includes a first switch electrode, a second switch electrode, an active layer, a dielectric layer and a light-shading layer. The active layer is disposed between and contacts with the first switch electrode and the second switch electrode. The active layer and the inducing electrode face each other and are separated from each other by a distance. The active layer, the first switch electrode and the second switch electrode cover the dielectric layer. The light-shading layer is disposed between the second substrate and the dielectric layer, and faces the active layer. When the first substrate or the second substrate is pressed so that the distance between the inducing electrode and the active layer is changed, the driven inducing electrode induces a channel corresponding to the change of the distance on the active layer so that the first switch electrode and the second switch electrode are electrically connected to each other, and a corresponding induced signal is generated between the first switch electrode and the second switch electrode when at least one of the first switch electrode and the second switch electrode is driven.

According to a third aspect of the present invention, a touch screen module including a touch screen panel and a readout circuit is provided. The touch screen panel includes a first substrate and a second substrate disposed opposite each other, a pixel array disposed between the first substrate and the second substrate, and a number of touch sensors. Each touch sensor includes an inducing electrode and an inducing switch. The inducing electrode is disposed on the first substrate. The inducing switch is disposed on the second substrate. The inducing switch includes a first switch electrode, a second switch electrode, an active layer, a dielectric layer and a light-shading layer. The active layer is disposed between and contacts with the first switch electrode and the second switch electrode. The active layer and the inducing electrode face each other and are separated from each other by a distance. The active layer, the first switch electrode and the second switch electrode cover the dielectric layer. The light-shading layer is disposed between the second substrate and the dielectric layer and opposite the active layer. When the first substrate or the second substrate is pressed so that the distance between the inducing electrode and the active layer is changed, the driven inducing electrode induces a channel corresponding to the change of the distance on the active layer so that the first switch electrode and the second switch electrode are electrically connected to each other, and a corresponding induced signal is generated between the first switch electrode and the second switch electrode when at least one of the first switch electrode and the second switch electrode is driven. The readout circuit receives an induced signal of one of the touch sensors, wherein the induced signal is a current signal. The readout circuit converts the current signal into an output signal.

According to a fourth aspect of the present invention, a touch sensor including a first substrate, a second substrate, an inducing electrode and an inducing switch is provided. The second substrate is disposed opposite the first substrate. The inducing electrode is disposed on the first substrate. The inducing switch is disposed on the second substrate and includes a source, a drain, an active layer and a gate. The active layer is disposed between and contacts with the source and the drain. The active layer and the inducing electrode face each other and are separated from each other by a distance. The gate faces the active layer and is floating. When the first substrate or the second substrate is pressed so that the distance between the inducing electrode and the active layer is changed, the driven inducing electrode induces a channel corresponding to the change of the distance on the active layer so that the source is electrically connected to the drain.

According to a fifth aspect of the present invention, a touch screen panel including a first substrate, a second substrate, a pixel array and a plurality of touch sensors is provided. The second substrate is disposed opposite the first substrate. The pixel array is disposed between the first substrate and the second substrate. Each of the touch sensors includes an inducing electrode and a thin-film transistor. The inducing electrode is disposed on the first substrate. The thin-film transistor is disposed on the second substrate. The thin-film transistor has a source, a drain, an active layer and a gate. The active layer is disposed between and contacts with the source and the drain. The active layer and the inducing electrode face each other and are separated from each other by a distance. The gate faces the active layer and is floating. When the first substrate or the second substrate is pressed so that the distance between the inducing electrode and the active layer is changed, the driven inducing electrode induces a channel corresponding to the change of the distance on the active layer so that the source is electrically connected to the drain, and a corresponding induced signal is generated between the source and the drain when at least one of the source and the drain is driven.

The invention will become apparent from the following detailed description of the preferred but non-limiting embodiments. The following description is made with reference to the accompanying drawings.

### BRIEF DESCRIPTION OF THE DRAWINGS

FIG. 1A is a structure diagram showing a touch sensor according to a first embodiment of the invention.

FIG. 1B is a structure diagram showing the touch sensor being pressed to induce a channel according to the first embodiment of the invention.

FIG. 1C is a structure diagram showing the touch sensor 110 applied to a touch screen panel according to the first embodiment of the invention.

FIG. 2A is a schematic circuit diagram showing the touch sensor according to the first embodiment of the invention.

FIG. 2B is a schematic circuit diagram showing the touch sensor being pressed to generate an induced signal according to the first embodiment of the invention.

FIG. 3A is a schematic illustration showing the touch sensor of FIG. 1C applied to a touch liquid crystal screen panel.

FIG. 3B is a cross-sectional view showing the touch liquid crystal screen panel taken along a line AA′ of FIG. 3A.

FIG. 4A is a schematic circuit diagram showing a touch liquid crystal screen panel according to a second embodiment of the invention.

FIG. 4B is a circuit diagram showing a touch liquid crystal screen panel according to a third embodiment of the invention.

FIG. 4C is a circuit diagram showing a touch liquid crystal screen panel according to a fourth embodiment of the invention.

FIG. 4D is a circuit diagram showing a touch liquid crystal screen panel according to a fifth embodiment of the invention.

FIG. 4E is a circuit diagram showing a touch liquid crystal screen panel according to a seventh embodiment of the invention.

FIG. 4F is a circuit diagram showing a touch liquid crystal screen panel according to an eighth embodiment of the invention.

FIG. 5 is a schematic circuit diagram showing a touch liquid crystal screen panel according to a ninth embodiment of the invention.

FIG. 6 is a schematic circuit diagram showing a touch liquid crystal screen panel according to a tenth embodiment of the invention.

FIG. 7 is a schematic circuit diagram showing a touch liquid crystal screen panel according to an eleventh embodiment of the invention.

FIG. 8 is a schematic circuit diagram showing a touch liquid crystal screen panel according to a twelfth embodiment of the invention.

FIG. 9 is a circuit diagram showing a touch liquid crystal screen panel according to a thirteenth embodiment of the invention.

FIG. 10 is a circuit diagram showing a touch liquid crystal screen panel according to a fourteenth embodiment of the invention.

FIG. 11A is a schematic illustration showing an example of a touch screen module applied to the embodiments of the invention.

FIG. 11B is a schematic illustration showing another example of the touch screen module applied to the embodiments of the invention.

FIGS. 12 to 16 are circuit diagrams showing examples of readout circuits for the touch screen module according to the embodiment of the invention.

### DETAILED DESCRIPTION OF THE INVENTION

### First Embodiment

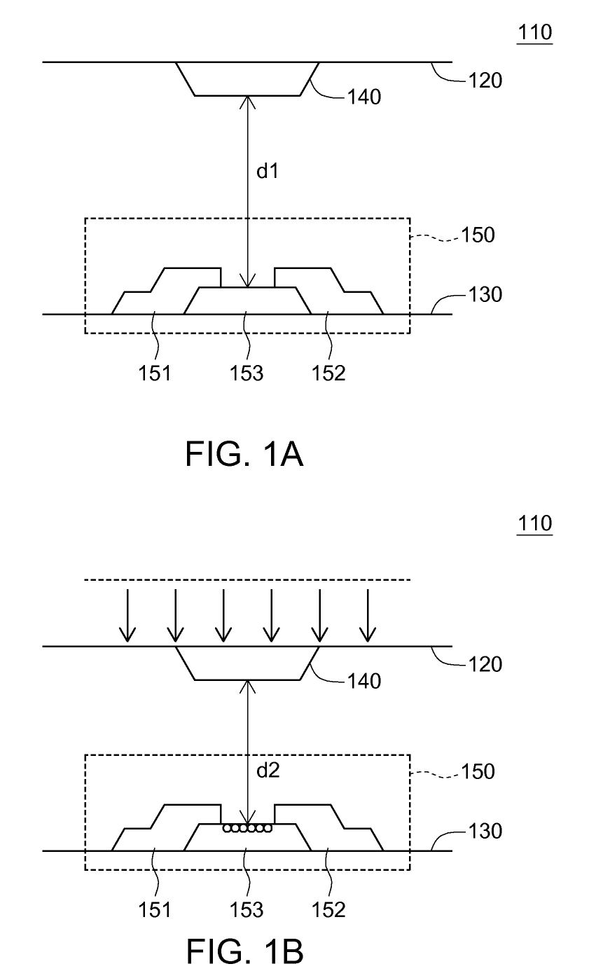

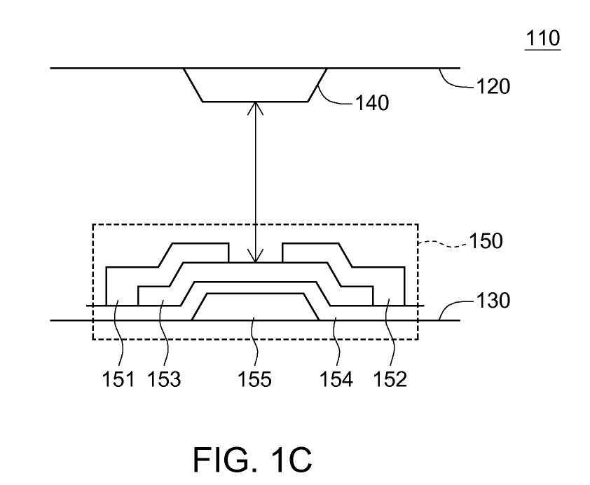

FIG. 1A is a structure diagram showing a touch sensor 110 according to a first embodiment of the invention. Referring to FIG. 1A, the touch sensor 110 includes a first substrate 120, a second substrate 130, an inducing electrode 140 and an inducing switch 150. The second substrate 130 is disposed opposite the first substrate 120. The inducing electrode 140 is disposed on the first substrate 120. The inducing switch 150 is disposed on the second substrate 130.

The inducing switch 150 includes a first switch electrode 151, a second switch electrode 152 and an active layer 153. The active layer 153 is disposed between and contacts with the first switch electrode 151 and the second switch electrode 152. The active layer 153 and the inducing electrode 140 face each other and are separated from each other by a distance d1. In this embodiment, the first switch electrode 151 and the second switch electrode 152 may be disposed on two sides of the active layer 153 and may partly cover the active layer 153. In other exemplary embodiments, the relationship in disposing the switch electrodes 151 and 152 and the compositions thereof may be modified. For example, the switch electrodes 151 and 152 may be respectively disposed on two sides of the active layer 153 and are electrically connected thereto. Also, the switch electrodes 151 and 152 may include metal layers and doped layers, such as n+ layers. Moreover, other doped layers may be added, or different materials may be used so as to enhance the conductive effect of the two switch electrodes 151 and 152 and the active layer 153.

FIG. 1B is a structure diagram showing the touch sensor being pressed to induce a channel according to the first embodiment of the invention. When the first substrate 120 or the second substrate 130 is pressed by an external force, the distance d1 between the inducing electrode 140 and the active layer 153 is reduced from the distance d1 of FIG. 1A to the distance d2 of FIG. 1B, for example. At this time, the driven inducing electrode 140 induces a channel corresponding to the change of the distance d1 on the active layer 153 so that the first switch electrode 151 is electrically connected to the second switch electrode 152.

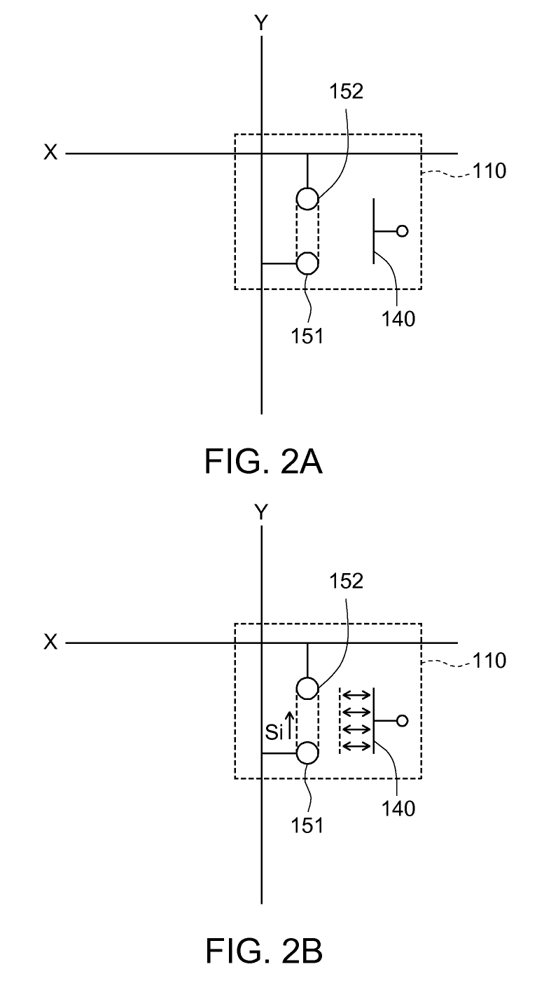

The schematic circuit diagram of the touch sensor 110 will be described in the following. FIGS. 2A and 2B are respectively schematic circuit diagrams showing the touch sensor, and the touch sensor being pressed to generate an induced signal according to the first embodiment of the invention. The inducing electrode 140 receives a first signal and is thus driven, the first switch electrode 151 receives a second signal from the trace Y and is thus driven, and the second switch electrode 152 receives a third signal from the trace X and is thus driven. In some embodiments, the second switch electrode 152 may also not receive the signal, but outputs an induced signal Si generated between the first switch electrode 151 and the second switch electrode 152 when the first switch electrode 151 is electrically connected to the second switch electrode 152, wherein the induced signal Si is outputted via the trace X.

When the first switch electrode 151 is electrically connected to the second switch electrode 152, the corresponding induced signal Si is generated, or the induced signal Si is changed, such as the change in the voltage value, current value, or waveform. Thus, the generation or the variation of the induced signal Si can reflect whether the touch sensor 110 is pressed, that is, whether the distance between the inducing electrode 140 and the active layer 153 of the touch sensor 110 is changed. In addition, when the touch sensor 110 returns to the state without being pressed from the pressed state and increases the distance thereof, the induced signal Si is also reflected accordingly. So, this condition may also be detected.

In this embodiment, the active layer 153 induces the channel, and the principle that the channel electrically connects the first switch electrode 151 to the second switch electrode 152 may be explained according to the principle of generating the channel in a top-gate field-effect transistor (FET). However, it is to be noted that the inducing electrode 140 of the touch sensor 110 is separated from the inducing switch 150 and correspondingly has a variable distance. The channel induced in the active layer 153 correspondingly relates to the change of the distance.

In addition, the methods of driving the inducing electrode 140 and the inducing switch 150 may be explained according to the method of driving the FET For example, in order to enable the active layer 153 to generate the channel, such as an n-channel, the method of driving the inducing electrode 140 should be configured such that the potential of the inducing electrode 140 can sufficiently induce the channel on the active layer 153 separated therefrom by a distance. Similarly, if the touch sensor 110 is provided to generate a p-channel, the consideration of the method of driving may be taken is a similar manner. Consequently, when the driven inducing electrode 140 and the active layer 153 are separated from each other by a certain distance, the channel can be induced on the active layer 153. Further, when the first switch electrode 151 and the second switch electrode 152 are driven properly at this time, such as driven by bias voltages or bias currents, the corresponding induced signal Si can be obtained from the first switch electrode 151 or the second switch electrode 152

In the operations of the inducing electrode 140 and the inducing switch 150 of the touch sensor 110, the principle of enabling the active layer 153 to induce the channel is different from the operation principle of the FET For the sake of illustration, however, in the following embodiments and drawings a circuit element symbol similar to the FET will be adopted to indicate the touch sensor of each embodiment of the invention.

In some embodiments of the invention, the touch sensor 110 may be applied to a touch screen panel. FIG. 1C is a structure diagram showing the touch sensor 110 applied to the touch screen panel according to the first embodiment of the invention. In FIG. 1C, the inducing switch 150 of FIG. 1A further includes a dielectric layer 154 and a light-shading layer 155. The active layer 153, the first switch electrode 151 and the second switch electrode 152 cover the dielectric layer 154. The light-shading layer 155 is disposed between the second substrate 130 and the dielectric layer 154 and opposite the active layer. In the typical touch screen panel using a backlight source, the light rays of the backlight source may enter from the second substrate 130 in this invention. So, when the touch sensor 110 of the invention is applied to the screen panel, the light-shading layer 155 can shade the light rays entering the second plate 130 and illuminating on the active layer 153 so as to prevent the active layer 153 from being influenced by the light source of the screen panel.

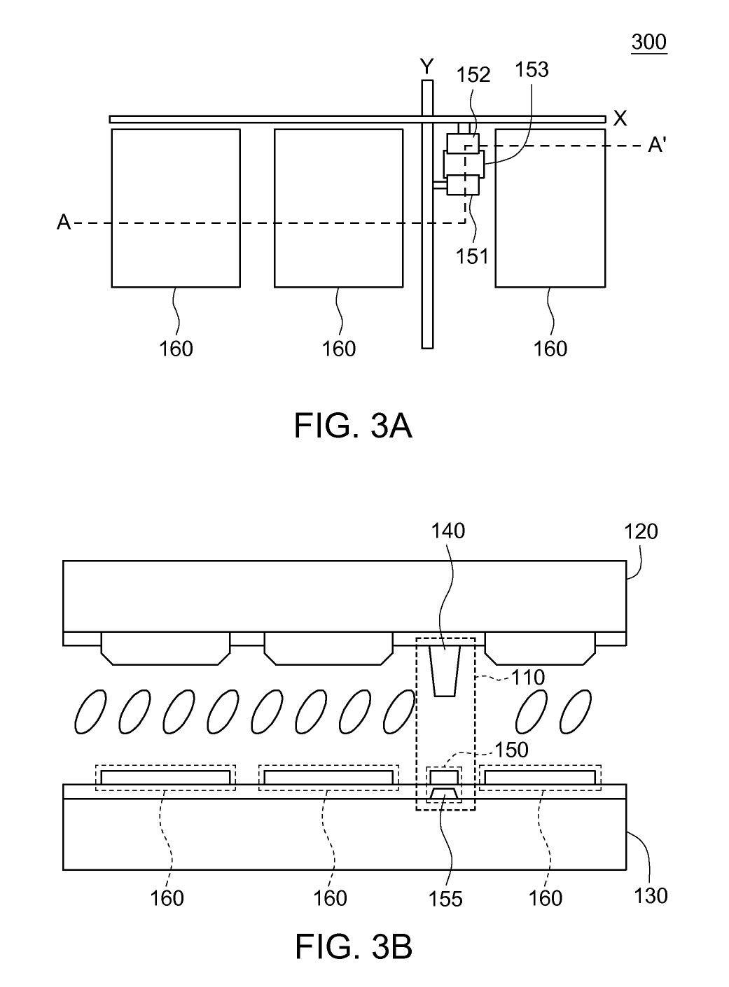

FIG. 3A is a schematic illustration showing the touch sensor of FIG. 1C applied to a touch liquid crystal screen panel 300. FIG. 3B is a cross-sectional view showing the touch liquid crystal screen panel taken along a line AA′ of FIG. 3A. Referring to FIGS. 3A and 3B, the liquid crystal screen panel 300 includes a first substrate 120, a second substrate 130, a pixel array and a plurality of touch sensors. For the sake of simplicity, FIGS. 3A and 3B illustrate one touch sensor 110 and three pixels 160 of the pixel array and will be described as an example. The second substrate 130 is disposed opposite the first substrate 120. The pixel array is disposed between the first substrate 120 and the second substrate 130. The three pixels 160 in FIGS. 3A and 3B may be regarded as three sub-pixels of a color liquid crystal screen panel.

Because the touch sensor 110 is disposed between the first substrate 120 and the second substrate 130 (e.g., disposed in the pixel array), the touch sensor 110 may be completely configured in the processes of manufacturing the screen panel so that the circuit of the touch sensor and the pixel array can be integrated in one touch screen panel. In a practical example, the inducing electrode 140 may be implemented by forming an electrode on a color filter substrate of a liquid crystal display, and the inducing switch 150 may be formed on the thin-film transistor substrate. In addition, in other examples, the inducing electrode 140 may be implemented by using a bump. Besides, the distance between the inducing electrode 140 and the inducing switch 150 may be designed according to the property of the dielectric material. The shape, length, width or depth of the inducing electrode 140 may be considered according to the electrical requirement of the actual layout and the property of the dielectric material. At all events, as disclosed in the consideration of the above-mentioned example in practice, the channel is preferred to be induced in the active layer 153 when the driven inducing electrode 140 and the inducing switch 150 are separated from each other by a predetermined distance.

Illustrations will be made by taking the touch sensor of the invention applied to the touch screen panel as an example according to many embodiments and implementations.

### Second Embodiment

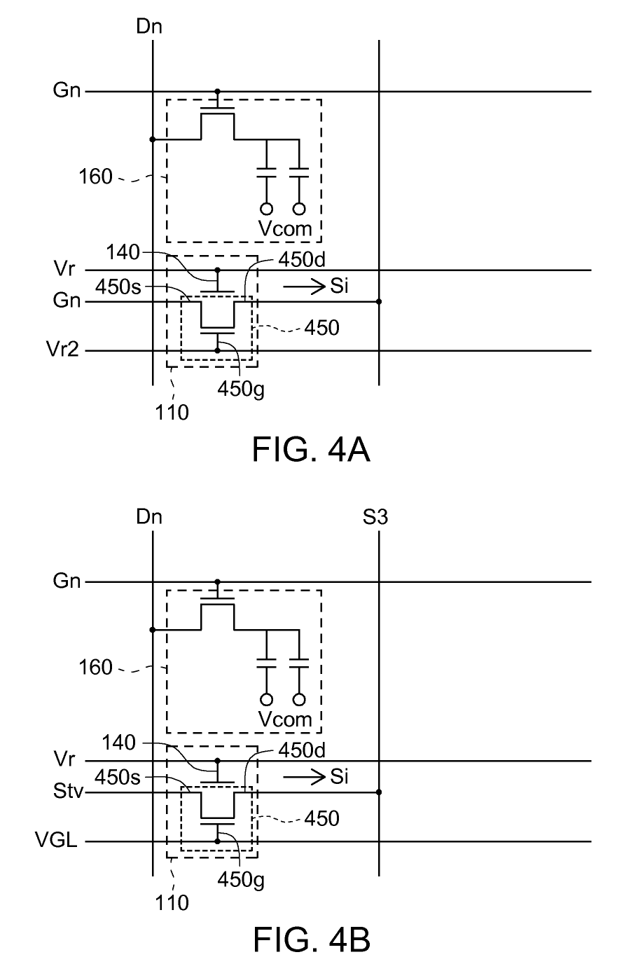

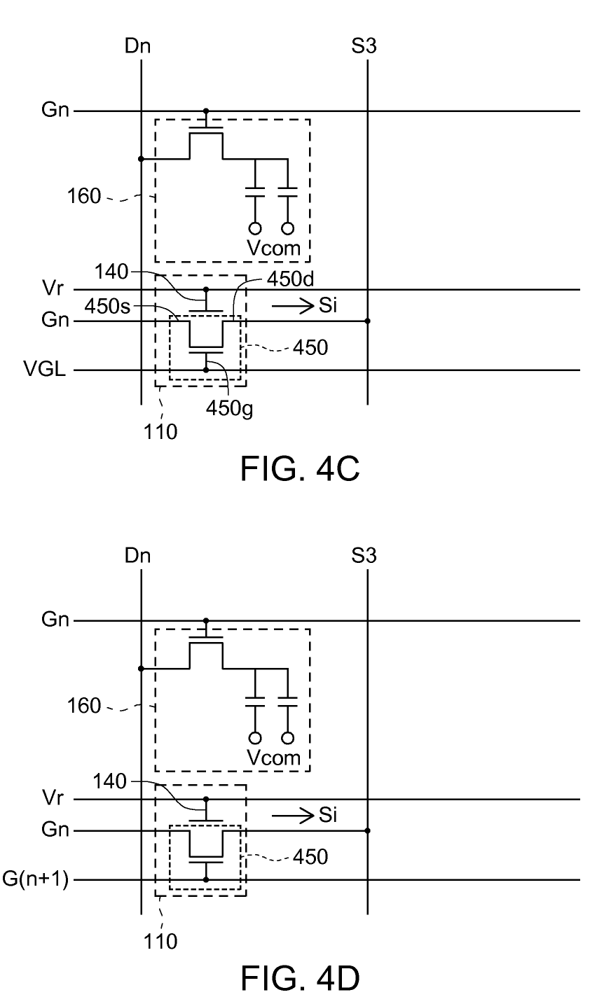

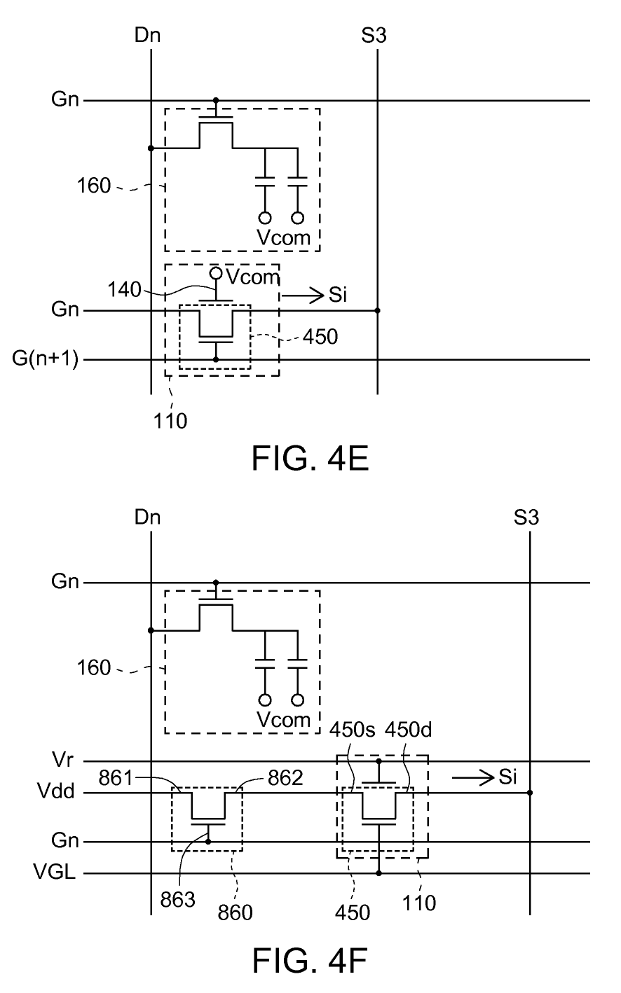

In this embodiment, the light-shading layer 155 of FIG. 1C is a control electrode having a metal material, for example. At this time, the first switch electrode 151, the second switch electrode 152 and the control electrode form a thin-film transistor (TFT) structure, for example. Illustrations will be made by taking the thin-film transistor for implementing the inducing switch 150 as an example. FIG. 4A is a schematic circuit diagram showing a touch liquid crystal screen panel according to a second embodiment of the invention. Referring to FIG. 4A, a thin-film transistor 450 has a source 450s, a drain 450d, a gate 450g and an active layer (not shown in FIG. 4A), which respectively correspond to the first switch electrode 151, the second switch electrode 152, the control electrode 155 and the active layer 153 of the inducing switch. The thin-film transistor 450 is, for example, an amorphous silicon thin-film transistor (amorphous silicon TFT), or a poly-silicon thin-film transistor (poly-silicon TFT).

The operations of this embodiment will be described in the following. As shown in FIG. 4A, the inducing electrode 140 receives a first signal, such as an external voltage signal Vr, and is thus driven. The source 450s receives a second signal and is thus driven, wherein the second signal is a voltage signal, such as a scanning signal Gn generated by a gate driver (not shown in FIG. 4A). The gate 450g receives a fourth signal, such as another external voltage signal Vr2, and is thus driven. When the source 450s is electrically connected to the drain 450d, a corresponding induced signal Si is generated, and the drain 450d outputs the induced signal Si. Thus, whether the touch sensor 110 is pressed can be obtained according to the generation or the variation of the induced signal Si.

In the layout patterns of the panel, the scanning signal Gn drives one row of the pixel array, such as the nth row. So, the touch sensors 110 for receiving the scanning signal Gn may be disposed near the row of the pixel array. Thus, in this embodiment, the source 450s of the touch sensor 110 receives the adjacent scanning signal Gn and is thus driven. Thus, the touch sensor 110 can be driven without using additional wires to receive signals far away, so that the circuit wiring may be saved, and the cost may be reduced.

In addition, when the thin-film transistor 450 is an amorphous silicon thin-film transistor, for example, the active layer of the thin-film transistor 450 may be induced by the light which can be referred to as photo-induced phenomenon, so that the gate of the thin-film transistor 450 may be regarded as a black matrix, and may also be a gate signal structure layer so as to avoid the photo-induced phenomenon.

According to this embodiment, it is obtained that the way of designing layout patterns may also relate to the source of driving signals for driving the touch sensor when the touch sensor and the pixel array are integrated in a touch screen panel. Thus, when the touch sensor is driven by different combinations of the driving signals, different circuit layouts patterns, such as the patterns in designing the associated traces, may be made according to the driving signals so that the touch screen panel according to the embodiment of the invention may thus be implemented.

### Third Embodiment

FIG. 4B is a circuit diagram showing a touch liquid crystal screen panel according to a third embodiment of the invention. In this embodiment, the source 450s receives a second signal, such as a vertical start signal Stv for triggering the gate driver, and is thus driven. The drain 450d receives a third signal, such as an external voltage signal S3, and is thus driven. The gate 450g receives a fourth signal, such as a gate low-voltage signal VGL generated by the gate driver, and is thus driven. When the source 450s is electrically connected to the drain 450d, a corresponding induced signal Si is generated, and the drain 450d outputs the induced signal Si. Thus, whether the touch sensor 110 is pressed may be obtained according to the generation or the variation of the induced signal Si.

### Fourth Embodiment

FIG. 4C is a circuit diagram showing a touch liquid crystal screen panel according to a fourth embodiment of the invention. What is different from the third embodiment is that the second signal for making the source 450s be driven is the scanning signal Gn, for example. When the source 450s is electrically connected to the drain 450d, an induced signal Si corresponding to the scanning signal Gn and the voltage signal S3 is generated, and the drain 450d outputs the induced signal Si.

Because the source 450s of the touch sensor 110 receives the scanning signal Gn and is thus driven, the touch sensor 110 can be driven without using additional wires to receive signals far away, so that the circuit wiring may be saved, and the cost may be reduced.

### Fifth Embodiment

FIG. 4D is a circuit diagram showing a touch liquid crystal screen panel according to a fifth embodiment of the invention. What is different from the fourth embodiment is that the fourth signal for making the gate 450g be driven is a scanning signal G(n+1) generated by the gate driver. When the source 450s is electrically connected to the drain 450d, an induced signal Si corresponding to the scanning signal Gn and the voltage signal S3 is generated.

In this embodiment, the source 450s and the gate 450g respectively receive the scanning signals Gn and G(n+1) and are thus driven, and the scanning signals Gn and G(n+1) are respectively for driving two rows of the pixel array, such as the n^{th} row and the (n+1)^{th} row, that is, the touch sensors 110 for receiving the scanning signals Gn and G(n+1) may be disposed between two adjacent rows of the pixel array. Thus, in this embodiment, the touch sensor 110 can be driven without using additional wires to receive signals far away, so that the circuit wiring may be saved, and the cost may not be reduced.

### Sixth Embodiment

Correspondingly, what is different from the fifth embodiment is that the source 450s and the gate 450g respectively receive the scanning signals G(n+1) and Gn generated by the gate driver and are thus driven. Because the scanning signals G(n+1) and Gn are respectively for driving two rows of the pixel array, the touch sensors 110 for receiving the scanning signals G(n+1) and Gn still may be disposed between two adjacent rows of the pixel array. Thus, in this embodiment, the touch sensor 110 can be driven without using additional wires to receive signals far away, so that the circuit wiring may be saved, and the cost may not be reduced.

In addition to the scanning signals G(n+1) and Gn serving as the driving sources, the scanning signals corresponding to any two rows may be adopted as the source of driving signals in other examples.

### Seventh Embodiment

FIG. 4E is a circuit diagram showing a touch liquid crystal screen panel according to a seventh embodiment of the invention. What is different from the fifth embodiment is that the first signal for making the inducing electrode 140 be driven is a common voltage Vcom, for example. The common voltage Vcom is originally for driving the pixel array, and the inducing electrode 140 can be driven through the common voltage Vcom in this embodiment. Thus, in t this embodiment, the touch sensor 110 can be driven without using additional wires to receive signals far away, so that the circuit wiring may be saved, and the cost may not be reduced.

### Eighth Embodiment

FIG. 4F is a circuit diagram showing a touch liquid crystal screen panel according to an eighth embodiment of the invention. What is different from the fourth embodiment is that the touch sensor further includes an auxiliary switch, such as a thin-film transistor 860, which is selectively turned on according to a fifth signal so that the driven thin-film transistor 860 is electrically connected to the source 450s and the source 450s is thus driven.

Referring to FIG. 4F, the thin-film transistor 860 has a first terminal 861, a second terminal 862 and a control terminal 863. The first terminal 861 receives a sixth signal, such as an external voltage signal Vdd, and is thus driven. The second terminal 862 is coupled to the source 450s. The control terminal 863 receives the fifth signal, such as the scanning signal Gn, and is thus driven. The scanning signal Gn is for driving the pixel 160. That is, the source 450s of the touch sensor 110 disposed adjacent to the pixel 160 receives the scanning signal Gn for driving the pixel 160, and is thus driven. In detail, when the auxiliary switch 860 is turned on and the touch sensor 110 is pressed to form a channel so that the source 450s is electrically connected to the drain 450d, a corresponding induced signal Si is generated between the driven source 450s and the drain 450d, and the drain 450d outputs the induced signal Si. Thus, whether the touch sensor 110 is pressed can be obtained according to whether the induced signal Si is generated.

Because the touch sensor 110 is separated from the driving circuit by the thin-film transistor 860, the source 450s of the touch sensor 110 is driven only when the thin-film transistor 860 is turned on. That is, the scanning signal Gn periodically turns on the thin-film transistor 860 so that the source 450s is driven. Thus, when the thin-film transistor 860 is not turned on, the touch sensor 110 may not generate the induced signal Si even if touch sensor 110 is pressed so that the power-saving effect can be achieved. Nevertheless, the ordinary user usually uses his/her finger or a touch pen to touch the touch screen panel for a longer period of time (e.g., longer than 0.2 seconds). So, the touch sensing effect may not be influenced as long as the time period, which the thin-film transistor 860 is turn-off, is shorter than the time period which the sensor is touched.

### Ninth Embodiment

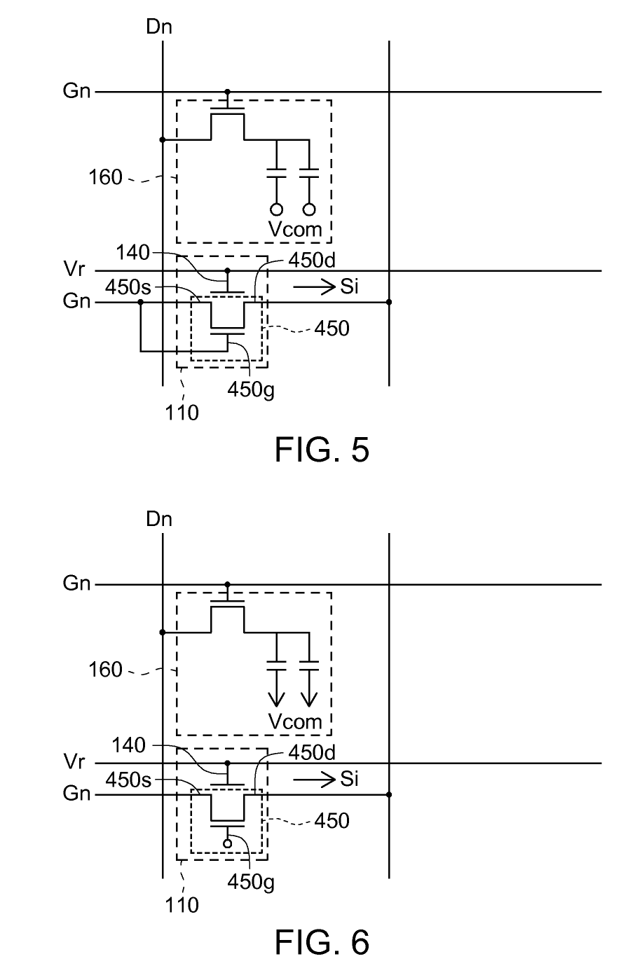

FIG. 5 is a schematic circuit diagram showing a touch liquid crystal screen panel according to a ninth embodiment of the invention. What is different from the second embodiment is that the control electrode is electrically connected to one of the first switch electrode 151 and the second switch electrode 152. That is, the gate 450g is electrically connected to one of the source 450s and the drain 450d. In FIG. 5, the gate 450g is illustrated as being electrically connected to the source 450s. Because the source 450s receives the scanning signal Gn and is thus driven, the gate 450g also receives the scanning signal Gn and is thus driven. Thus, the thin-film transistor 450 of this embodiment may be regarded as a diode element.

When the voltage signal Vr induces a channel so that the source 450s is electrically connected to the drain 450d (i.e., the diode element is turned on), an induced signal Si corresponding to the scanning signal Gn is generated. Thus, this embodiment may also obtain whether the touch sensor 110 is pressed according the generation or the variation of the induced signal Si.

### Tenth Embodiment

FIG. 6 is a schematic circuit diagram showing a touch liquid crystal screen panel according to a tenth embodiment of the invention. In this embodiment, the gate 450g does not receive the signal and thus is not driven.

In each of the embodiments mentioned hereinabove, the gate 450g receives the fourth signal, such as the voltage signal Vr2, the gate low-voltage signal, or the scanning signal Gn, and is thus driven. In practice, however, the applicant found that an electric field is generated when the gate 450g (i.e., the light-shading layer 155 of FIG. 1C, which is a control electrode having a metal material) receives the voltage signal and is thus driven. The electric field may influence the ability of the inducing electrode 140 of inducing the channel on the active layer 153.

Furthermore, the applicant also found that the distance between the active layer 153 and the gate 450g on the second substrate 130 is relatively shorter (about 1000 to 2000 angstroms), while the distance between the active layer 153 on the second substrate 130 and the inducing electrode 140 on the first substrate 120 is relatively longer (about 1 to 2 microns (μm)). Thus, the size of the electric field generated by the gate 450g on the active layer 153 is higher than the electric field generated by the inducing electrode 140 on the active layer 153 under the condition of using the same driving signal. Consequently, when the active layer 153 is induced to form the channel, the driven gate 450g may influence the ability of the inducing electrode 140 of inducing the channel so that the sensitivity of the inducing electrode 140 with respect to the induced channel is decreased. So, in this embodiment, the gate 450g is configured to be floating and is thus not driven so that the influence of the gate 450g may be decreased when the inducing electrode 140 is inducing the channel.

Thus, when the source 450s is electrically connected to the drain 450d, an induced signal Si is induced. In addition, the floating gate 450g may make the inducing electrode 140 increase the sensitivity with respect to the induced signal Si. Therefore, this embodiment can obtain whether the touch sensor 110 is pressed according to the generation or the variation of the induced signal Si, and can have better sensing sensitivity in sensing whether the touch sensor is pressed.

### Eleventh Embodiment

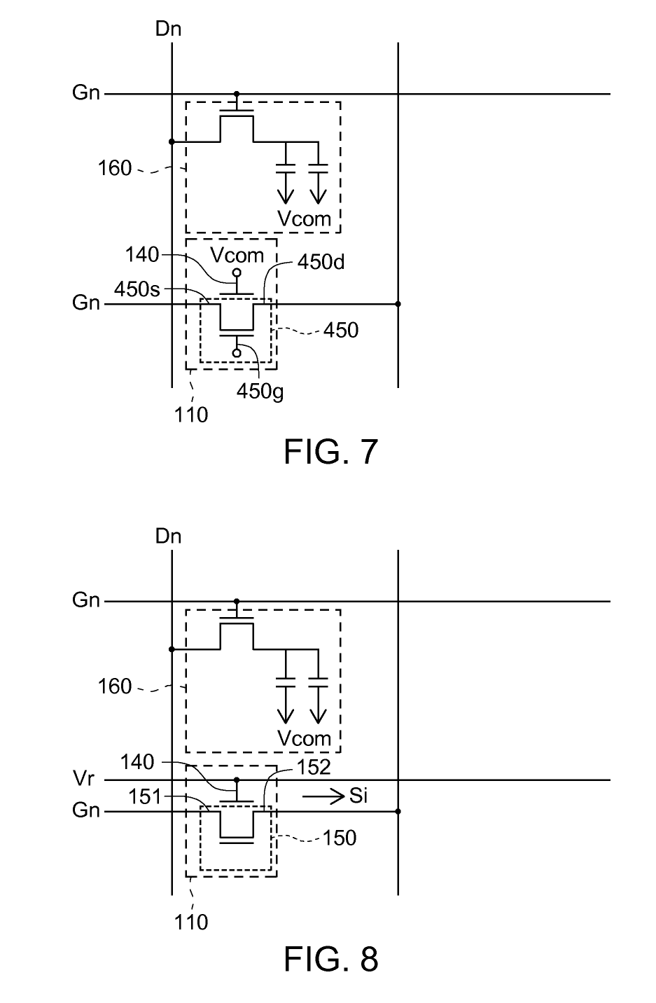

FIG. 7 is a schematic circuit diagram showing a touch liquid crystal screen panel according to an eleventh embodiment of the invention. What is different from the tenth embodiment is that the inducing electrode 140 receives the common voltage Vcom and is thus driven, for example. The source 450s receives the scanning signal Gn and is thus driven, and the gate 450g is floating. The drain 450d outputs the induced signal Si.

### Twelfth Embodiment

In this embodiment, for example, the light-shading layer 155 of the touch sensor 110 of FIG. 1C is a black matrix having an insulating material. FIG. 8 is a schematic circuit diagram showing a touch liquid crystal screen panel according to a twelfth embodiment of the invention. In this embodiment, the black matrix made of the insulating material serves as the light-shading layer and is thus different from the control electrode made of the metal material in the second embodiment. Thus, the symbol of the circuit element is similar to the field effect transistor, but is referred to as the field effect transistor without gate, which is adopted to indicate the touch sensor of this embodiment, as depicted in the touch sensor 110 of FIG. 8.

In this embodiment, the inducing electrode 140 receives the external voltage signal Vr and is thus driven, and the first switch electrode 151 of the touch sensor 110 receives the scanning signal Gn and is thus driven. When the first switch electrode 151 is electrically connected to the second switch electrode 152, a corresponding induced signal Si is generated, and the second switch electrode 152 outputs the induced signal Si. Thus, whether the touch sensor 110 is pressed can be obtained according to the generation or the variation of the induced signal Si.

The touch sensor 110 of this embodiment also may not influence the sensitivity of the inducing electrode 140 of inducing the channel on the active layer 153, which is explained below. In the above-mentioned tenth and eleventh embodiments, the light-shading layer 155 having the metal material is floating. In this embodiment, the black matrix having the insulating material is served as the light-shading layer 155, so the insulated light-shading layer 155 also may not generate the electric field, and the sensitivity of the inducing electrode 140 of inducing the channel on the active layer 153 may not be influenced. Thus, this embodiment can obtain whether the touch sensor 110 is pressed, and can have better sensing sensitivity in sensing whether the touch sensor is pressed.

### Thirteenth Embodiment

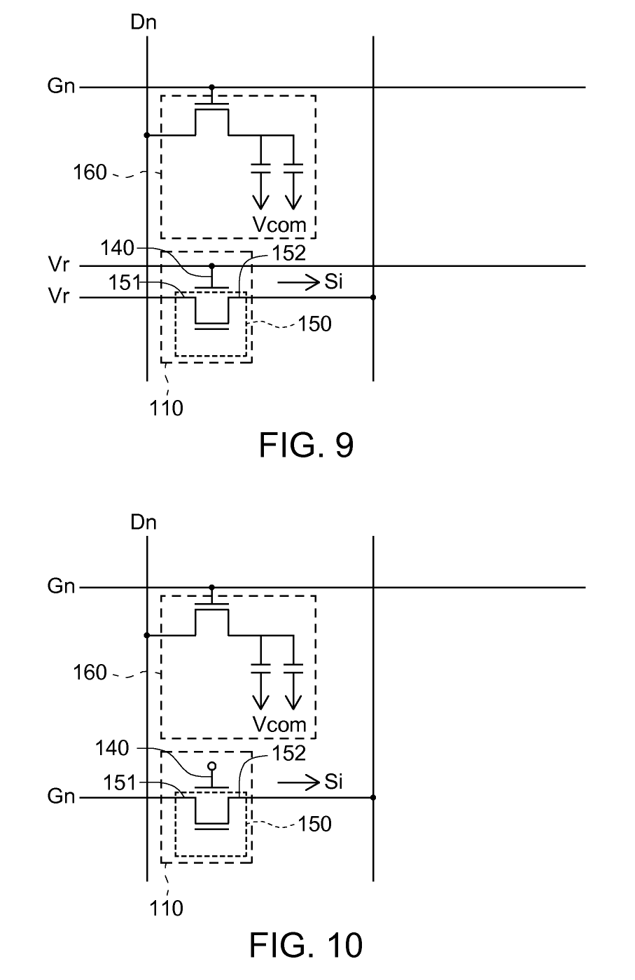

FIG. 9 is a circuit diagram showing a touch liquid crystal screen panel according to a thirteenth embodiment of the invention. What is different from the twelfth embodiment is that the inducing electrode 140 receives a voltage signal Vr and is thus driven, the first switch electrode 151 also receives the voltage signal Vr and is thus driven, and the second switch electrode 152 is for outputting the induced signal Si.

### Fourteenth Embodiment

FIG. 10 is a circuit diagram showing a touch liquid crystal screen panel according to a fourteenth embodiment of the invention. What is different from the twelfth embodiment is that the inducing electrode 140 receives the common voltage Vcom and is thus driven, the first switch electrode 151 receives the scanning signal Gn and is thus driven, and the second switch electrode 152 is for outputting the induced signal Si.

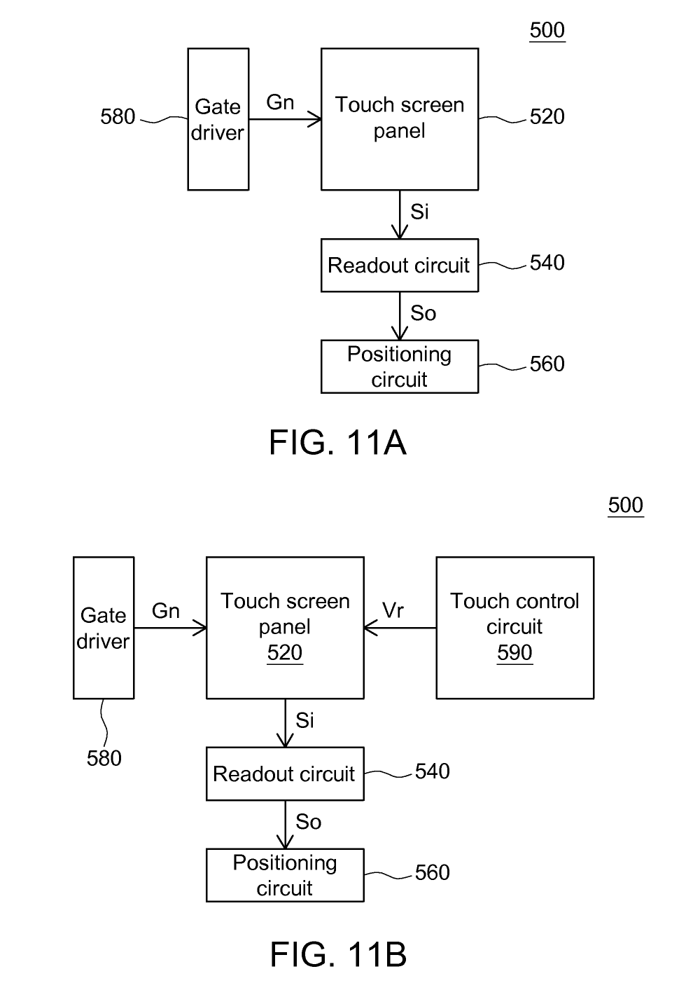

In the embodiment according to the invention, the touch sensor 110 may also be applied to a touch screen module. FIG. 11A is a schematic illustration showing an example of a touch screen module applied to the embodiment of the invention. As shown in FIG. 11A, the touch screen module 500 obtains whether the touch sensor is pressed according to the generation or the variation of the induced signal Si. In some examples, the touch screen module 500 judges the touched position according to at least one induced signal.

In FIG. 11A, the touch screen module 500 includes a touch screen panel 520, a readout circuit (also referred to as a readout integrated circuit, Readout-IC) 540, a positioning circuit 560 and a gate driver 580. The touch screen panel 520 is, for example, the touch screen panel applied to the touch sensor 110 of one of the second to fourteenth embodiments of the invention.

Furthermore, as shown in FIG. 11A, the touch screen panel 520 receives the scanning signal Gn of the gate driver 580 and is thus driven. However, the invention is not limited thereto. FIG. 11B is a schematic illustration showing another example of the touch screen module applied to the embodiments of the invention. Referring to FIG. 11B, the touch screen module 500 may further include a touch control circuit 590, which provides, for example, the voltage signal S3, Vdd, Vr or Vr2 to drive the touch screen panel 520. Thus, in the embodiment of the invention, the driving signal of the touch screen panel 520 may include at least one of the scanning signal Gn, the voltage signals Vr and Vr2. That is, the touch screen panel 520 may be driven by the gate driver 580 for driving the pixel array, as shown in FIG. 11A. Alternatively, the touch screen panel 520 may also be driven by the gate driver 580 and an external circuit (e.g. the touch control circuit 590), as shown in FIG. 11B.

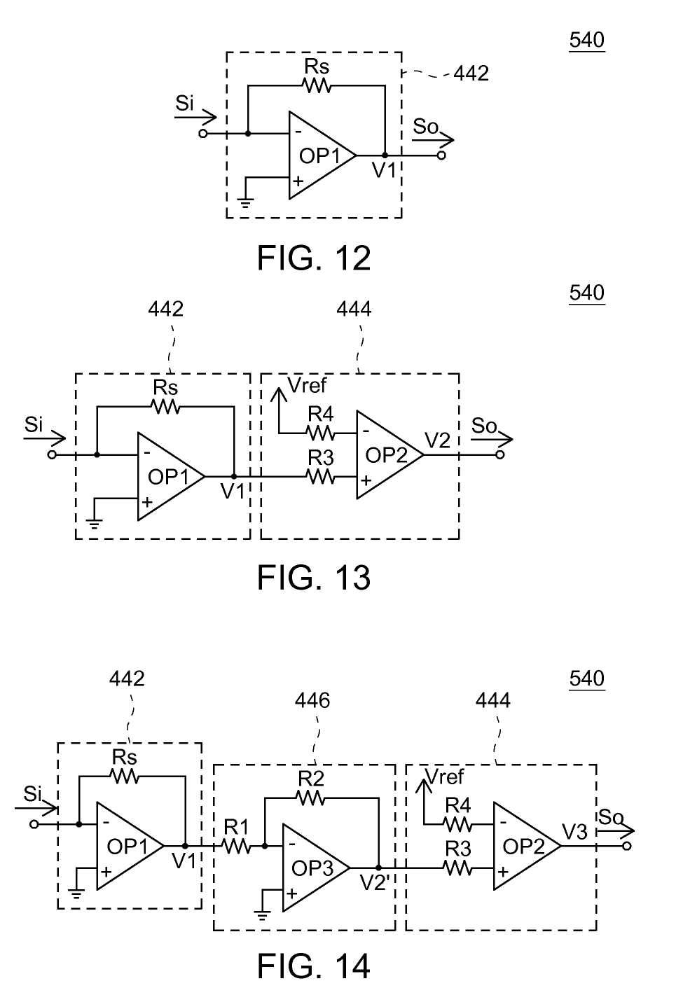

Illustrations will be made by taking the touch screen module 500 of FIG. 11A as an example. In FIG. 11A, the readout circuit 540 receives the induced signal Si of one of the touch sensors, wherein the induced signal Si is a current signal. The readout circuit 540 converts the current signal into an output signal So. FIGS. 12 to 16 are circuit diagrams showing examples of the readout circuits 540 for the touch screen module according to the embodiment of the invention. In FIG. 12, the readout circuit 540 includes a current-to-voltage amplifier 442, which includes, for example, an operational amplifier OP1 for converting the induced signal Si of the current signal into a first voltage signal V1, which will be serving as the output signal So of the readout circuit 540.

In FIG. 13, the readout circuit 540 includes the current-to-voltage amplifier 442 of FIG. 12 and a comparing amplifier 444. The comparing amplifier includes, for example, an operational amplifier OP2 for comparing the first voltage signal V1 with a reference voltage Vref, so as to output a second voltage signal V2 serving as the output signal So of the readout circuit 540.

In FIG. 14, the readout circuit 540 includes the current-to-voltage amplifier 442 of FIG. 12, an inverting amplifier 446, and a comparing amplifier 444. The inverting amplifier 446 including, for example, an operational amplifier OP3 is for inverting and amplifying the first voltage signal V1 into a second voltage signal V2′. The comparing amplifier 444 compares the second voltage signal V2′ with a reference voltage Vref2, and thus outputs a third voltage signal V3 serving as the output signal So of the readout circuit 540.

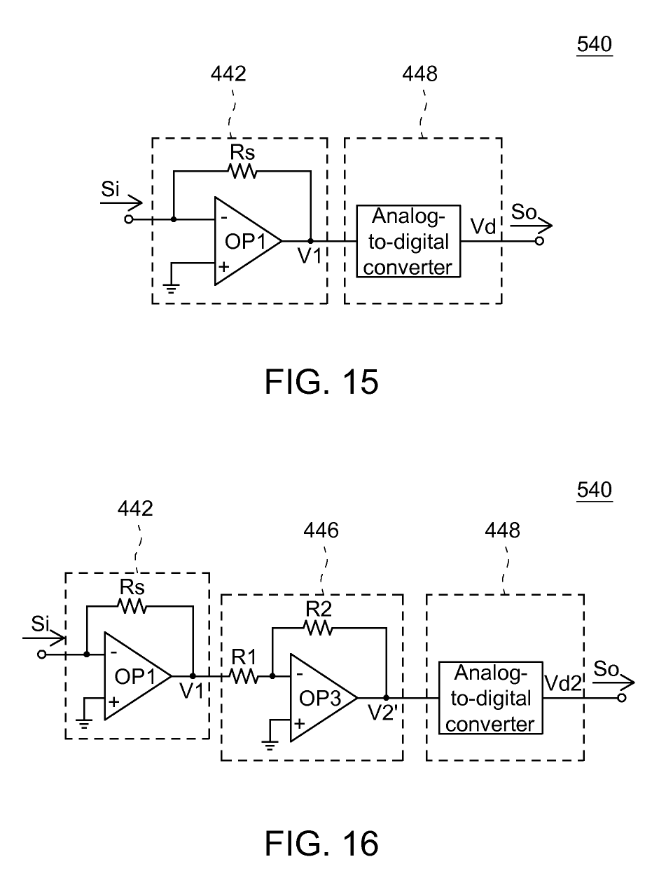

In FIG. 15, the readout circuit 540 includes the current-to-voltage amplifier 442 of FIG. 12, and an analog-to-digital converter (ADC) 448. The ADC 448 is for converting the analog first voltage signal V1 into a digital voltage signal Vd, which will be serving as the output signal So of the readout circuit 540.

In FIG. 16, the readout circuit 540 includes the current-to-voltage amplifier 442 of FIG. 12, an inverting amplifier 446 and an ADC 448. The ADC 448 is for converting the analog second voltage signal V2′ into a digital voltage signal Vd2, which will be serving as the output signal So of the readout circuit 540.

In the examples of FIGS. 12 to 16, the readout circuit 540 may be configured to read the induced signal Si according to the circuit property of the practical touch sensor. Moreover, according to the induced signal Si, such as the corresponding current variation, the readout circuit 540 may be applied to the implementations of analyzing whether the touch sensor 110 is pressed or analyzing the pressed position. In these examples, the induced signal Si received by the readout circuit 540 is the current signal. That is, the induced signal Si sensed by the touch sensor is the current signal. Compared with the voltage signal, the current signal may not be easily influenced by the voltage coupling effect between the elements on the panel layout patterns in the touch screen panel 520. Therefore, the induced signal Si can be stably transferred to the external readout circuit 540 of the panel.

As shown in FIG. 11A, a column of the touch sensors is coupled to the readout circuit 540 in order to together output the above-mentioned induced signals Si in one embodiment. Thus, when the readout circuit 540 provides the output signal So according to the induced signal Si, the positioning circuit 560 may position the touched position of the touch screen panel 520 according to the output signal So outputted from the readout circuit 540.

In another practical example, the gate driver 580 generates the scanning signal Gn to drive one row of the pixel array. The touch screen panel 520 displays images under the driving of the gate driver 580. One row of the touch sensors receives the scanning signal Gn and is thus driven, and the row of the touch sensors receiving the scanning signal Gn is disposed near the row of the pixel array. Thus, the positioning circuit 560 may further judge whether or not the induced signal Si is generated from the row of the touch sensors according to the scanning signal Gn, and judges the touched position of the touch sensor according to the induced signal Si. Thus, the touched position of the touch sensor may be positioned as the touched position of the touch screen panel 520. That is, when the readout circuit 540 receives the induced signal Si from one column of the touch sensors and outputs the signal So, the positioning circuit 560 may position the touched position of the touch screen panel 520 according to at least the scanning signal Gn and the output signal So.

For example, the touch screen module 500 can position the touched position of the screen panel 520 (e.g., the screen panel 520 of the second embodiment) according to each of the embodiments of the invention according to the scanning signal Gn and the output signal So. Because the touched touch sensor is driven by the scanning signal Gn, which is for driving one row (transversal row) of pixels, this touch sensor is disposed near the row of pixels. Thus, the positioning circuit 560 can judge the longitudinal coordinate Dy of the touch sensor on the touch screen panel 520 according to the scanning signal Gn.

Furthermore, it is assumed that the touched touch sensor is the Y^{th} touch sensor in one row of touch sensors so that the touch sensors including one column (longitudinal column) of the Y^{th} touch sensor together output the induced signals Si. Thus, when the readout circuit 540 receives the induced signal Si and the positioning circuit 560 detects the output signal So, the positioning circuit 560 can judge the transversal coordinate Dx of the touched touch sensor on the touch screen panel 520. Thus, the positioning circuit 560 can position the touched position of the touch sensor according to the transversal coordinate and the longitudinal coordinates (Dx, Dy) and thus obtain the touched position of the touch screen panel 520.

In the example, in which the touch sensor receives the scanning signal Gn and is thus driven, the touch screen module 500 may further include a controller (not shown). The controller controls the gate driver 580 to sequentially output the scanning signal. That is, the controller may control the timing of the scanning signal Gn, and the positioning circuit 560 can perform the positioning operation on the driven touch sensors according to the timing controlled by the controller. In practice, the positioning circuit 560 may be implemented in the internal circuit of the controller. For example, the controller may be implemented by a field programmable gate array (FPGA), and the positioning circuit 560 may be implemented in the logic gate array of FPGA. However, the invention is not limited thereto, and the positioning circuit 560 may also be implemented in an external circuit of the controller as long as the positioning circuit can position the touched position according to the induced signal Si.

In each of the embodiments, in which the touch sensor and the pixel array are integrated, a pixel and a touch sensor are illustrated as an example. In other embodiments, however, the touch sensors and the pixels may have different combinations. For example, the touch sensors and the pixels may be disposed in the pixel array in predetermined or different distribution ratios. Also, some touch sensors may be disposed or extended out of a display region of the pixel array for other applications. For example, multiple touch sensors are disposed in the pixel array, and multiple induced signals induced when the touch sensors are touched may be detected. Thus, the touch positions of different fingers or objects on the panel may be positioned at the same time so that the multi-touch screen panel may be achieved. In addition, the single-touch screen panel may also be designed by detecting the induced signal and according to the requirements in actual applications.

In addition, the integration method of the liquid crystal panel is described in the above-mentioned embodiments. However, in the technology for other screen panel, the touch screen panel of the invention may be implemented by constructing the touch sensors between the upper and lower substrates. In addition, the inducing switch and the auxiliary switch of the touch screen panel according to each embodiment are implemented by the thin-film transistors. However, the invention is not limited thereto. In the technology for other panels, the touch screen panel of each of the embodiments may be implemented as long as the inducing electrode can make the switch generate the channel.

The touch sensor according to the embodiment of the invention is disposed between the first panel and the second panel. Thus, the touch sensors may be formed while the screen panel is being manufactured so that a touch screen panel integrating with the panel manufacturing processes may be obtained. In addition, in the touch liquid crystal screen panel according to each of the embodiments of the invention, the touch sensor can receive the adjacent scanning signal provided by the gate driver and is thus driven. So, the touch sensor can be driven without using additional wires to receive signals far away, so that the circuit wiring may be saved, and the cost may be reduced. Furthermore, in some embodiments, the pressed touch sensor may selectively generate the induced signal by selectively turning on the auxiliary switch so that the power-saving effect can be achieved. In addition, the touch event or the touched position is sensed according to the induced channel generated under pressure in each of the embodiments of the invention. So, the touch panel of the invention is free from the significant influence on the variation of the ambient light in the optical touch panel, and is free from the limitation of the capacitive touch panel, in which only the conductive object (e.g., the finger) on the panel can be sensed.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch sensor, comprising:
a first substrate;
a second substrate disposed opposite the first substrate;
an inducing electrode disposed on the first substrate; and
an inducing switch disposed on the second substrate and comprising:
a first switch electrode and a second switch electrode; and
an active layer, which is disposed between and contacts with the first switch electrode and the second switch electrode, wherein the active layer and the inducing electrode face each other and are separated from each other by a distance,
wherein when the first substrate or the second substrate is pressed so that the distance between the inducing electrode and the active layer is changed, the inducing electrode, which is driven, induces a corresponding channel on the active layer to electrically connect the first switch electrode to the second switch electrode.

2. The touch sensor according to claim 1, wherein the first switch electrode and the second switch electrode are disposed on two sides of the active layer and partly cover the active layer.

3. The touch sensor according to claim 1 being applied to a touch screen panel, wherein the inducing switch further comprises:
a dielectric layer, wherein the active layer, the first switch electrode and the second switch electrode cover the dielectric layer; and
a light-shading layer disposed between the second substrate and the dielectric layer and facing the active layer.

4. The touch sensor according to claim 3, wherein the light-shading layer has a black matrix made of an insulating material.

5. The touch sensor according to claim 3, wherein the light-shading layer has a control electrode made of a metal material.

6. The touch sensor according to claim 5, wherein the control electrode is floating.

7. A touch screen panel, comprising:
a first substrate;
a second substrate disposed opposite the first substrate;
a pixel array disposed between the first substrate and the second substrate; and
a plurality of touch sensors each comprising:
an inducing electrode disposed on the first substrate; and
an inducing switch disposed on the second substrate and comprising:
a first switch electrode and a second switch electrode;
an active layer disposed between and contacting with the first switch electrode and the second switch electrode, wherein the active layer and the inducing electrode face each other and are separated from each other by a distance;
a dielectric layer, wherein the active layer the first switch electrode and the second switch electrode cover the dielectric layer; and
a light-shading layer disposed between the second substrate and the dielectric layer and facing the active layer;
wherein when the first substrate or the second substrate is pressed so that the distance between the inducing electrode and the active layer is changed, the inducing electrode, which is driven, induces a corresponding channel on the active layer to electrically connect the first switch electrode to the second switch electrode, and a corresponding induced signal is generated between the first switch electrode and the second switch electrode when at least one of the first switch electrode and the second switch electrode is driven.

8. The touch screen panel according to claim 7, wherein the first switch electrode and the second switch electrode are disposed on two sides of the active layer and partly cover the active layer.

9. The touch screen panel according to claim 7, wherein the inducing electrode receives a first signal and is thus driven.

10. The touch screen panel according to claim 9, wherein the first signal is a voltage signal.

11. The touch screen panel according to claim 10, wherein the first signal is a common voltage for driving the pixel array.

12. The touch screen panel according to claim 7, wherein the first switch electrode receives a second signal and is thus driven.

13. The touch screen panel according to claim 12, wherein the second switch electrode is for outputting the induced signal.

14. The touch screen panel according to claim 12, wherein the second signal is a voltage signal.

15. The touch screen panel according to claim 12, wherein the second signal is generated by a gate driver.

16. The touch screen panel according to claim 15, wherein the second signal is one of a vertical start signal, a gate low-voltage signal, and a scanning signal which is for driving one row of the pixel array.

17. The touch screen panel according to claim 16, wherein the touch sensors for receiving the second signal are disposed near the row of the pixel array.

18. The touch screen panel according to claim 12, wherein the second switch electrode receives a third signal and is thus driven.

19. The touch screen panel according to claim 18, wherein the third signal is a voltage signal.

20. The touch screen panel according to claim 7, wherein the light-shading layer has a black matrix made of an insulating material.

21. The touch screen panel according to claim 7, wherein the light-shading layer has a control electrode made of a metal material.

22. The touch screen panel according to claim 21, wherein the control electrode is floating.

23. The touch screen panel according to claim 21, wherein the control electrode receives a fourth signal and is thus driven.

24. The touch screen panel according to claim 23, wherein the fourth signal is a voltage signal.

25. The touch screen panel according to claim 24, wherein the fourth signal is generated by a gate driver.

26. The touch screen panel according to claim 25, wherein the fourth signal is one of a vertical start signal, a gate low-voltage signal, and a scanning signal which is for driving one row of the pixel array.

27. The touch screen panel according to claim 21, wherein the first switch electrode and the control electrode respectively receive a first scanning signal and a second scanning signal generated by a gate driver, and are thus driven, and the first scanning signal and the second scanning signal are for driving two rows of the pixel array.

28. The touch screen panel according to claim 27, wherein the two rows of the pixel array driven by the first scanning signal and the second scanning signal are adjacent to each other.

29. The touch screen panel according to claim 28, wherein the touch sensors for receiving the first scanning signal and the second scanning signal are disposed near the two rows of the pixel array.

30. The touch screen panel according to claim 7, wherein the touch sensor further comprises:
an auxiliary switch, which is selectively turned on according to a fifth signal to electrically connect the auxiliary switch being driven to the first switch electrode so that the first switch electrode is driven.

31. The touch screen panel according to claim 30, wherein the fifth signal is a voltage signal.

32. The touch screen panel according to claim 30, wherein the fifth signal is generated by a gate driver.

33. The touch screen panel according to claim 32, wherein the fifth signal is one of a vertical start signal, a gate low-voltage signal, and a scanning signal which is for driving one row of the pixel array.

34. The touch screen panel according to claim 30, wherein the auxiliary switch is a thin-film transistor.

35. The touch screen panel according to claim 30, wherein the auxiliary switch is disposed on the second substrate and has:
a first terminal;
a second terminal coupled to the first switch electrode; and
a control terminal for receiving the fifth signal,
wherein the auxiliary switch is turned on according to the fifth signal so that the first terminal of the driven auxiliary switch is electrically connected to the first switch electrode and the first switch electrode is thus driven.

36. The touch screen panel according to claim 35, wherein the first terminal receives a sixth signal and is thus driven.

37. The touch screen panel according to claim 21, wherein the control electrode is electrically connected to one of the first switch electrode and the second switch electrode.
